(19) United States
(12) Patent Application Publication
(10) Pub. No.: US 2014/0264217 A1
(43) Pub. Date: Sep. 18, 2014

(54) Electric Fence Energizer Systems

(71) Applicants: Geoffrey C. Callahan, Salem, OH (US); Trent A. McElhaney, North Jackson, OH (US)

(72) Inventors: Geoffrey C. Callahan, Salem, OH (US); Trent A. McElhaney, North Jackson, OH (US)

(73) Assignee: Agratronix LLC, Streetsboro, OH (US)

(21) Appl. No.: 13/804,528

(22) Filed: Mar. 14, 2013

(51) Int. Cl. A01K 3/00; H05C 1/00

(52) U.S. Cl. CPC A01K 3/005; H05C 1/00
USPC 256/10

(57) ABSTRACT

An electric fence energizer system includes a main electrical energizer to supply a main voltage to the system and a remote electrical energizer to supply a supplemental voltage to the system.

### TECHNICAL FIELD

This invention relates to electric fence systems which function to prevent or at least inhibit animals from crossing a fence barrier by supplying an electrical shock to animals which come into contact with the fence. Electric fence systems are often used, for example, in the agricultural industry to hold livestock within a stockade area enclosed by a fence perimeter. They can also be used to prevent unwanted animals from entering a protected area enclosed by the electric fence perimeter.

### BACKGROUND OF THE INVENTION

Fences are erected to keep livestock animals in, and to keep unwanted animals out, of an enclosed area defined by the fence. Physical fence barriers including stone walls, wooden palisades or rails, wires such as barbed wires strung on supporting posts or the like, and other structures have been well known for a very long time. With the advent of electricity, fences have been energized to replace or supplement such traditional physical constraints with an electric shock supplied to an animal which comes into contact with the fence. Upon receiving the electric shock from the fence, the animal is likely to turn away and travel in a different direction rather than continuing to try to breach the fence.

### SUMMARY

Exemplary embodiments of electric fence energizer systems are disclosed herein. One exemplary electrical fence energizer system includes a main electrical energizer connected to at least one electrically conductive hot wire which forms a fence perimeter to supply a main voltage to the at least one hot wire. The system additionally includes a remote electrical energizer disposed along the fence perimeter and connected to the at least one hot wire to supply a supplemental voltage to the at least one hot wire. Related methods are also provided.

### BRIEF DESCRIPTION OF THE DRAWINGS

These and other features and advantages of the present invention will become better understood with regard to the following written description and the sole accompanying drawing FIG. 1 which is a schematic top view of an electric fence system 100.

### DETAILED DESCRIPTION

FIG. 1 is a schematic top view of an electric fence system 100. The system 100 includes a main electrical energizer 102 and at least one electrically conductive wire 104 connected to the main electrical energizer 102. While FIG. 1 illustrates just one conductive wire 104, one of ordinary skill in the art will understand that in actual practice it is more common for several wires 104 to be connected to the main electrical energizer 102. The one or more wires 104 extend out from the main electrical energizer 102 to define a perimeter or border 106 between an enclosed area 108 and an outer area 110. Various supporting elements 112 are placed in the ground in order to support the wires 104 above the ground, at a height at which animals are likely to encounter the wires 104 when attempting to cross the perimeter 106. The electric fence system 100 is erected to keep animals such as livestock within the enclosed area 108, and/or to prevent unwanted animals from entering the enclosed area 108 from the outer area 110. The enclosed area 108 protected by the fence may be used to contain livestock, to grow crops, or for any other purpose. Electric fence systems 100 are also used for human security purposes, such as to keep inmates in a prison 108 or unauthorized personnel away from a secured premises 108.

The main electrical energizer 102 contains an electrical power source connection 114. The power connection 114 may be used to provide electrical power to the main electrical energizer 102. The power connection 114 may include, for example, a wire and plug which can be inserted into a standard electrical outlet leading to the electrical mains of a municipal power grid or to a private electricity generator. In other embodiments, the power connection 114 may include leads for connecting to opposing terminals of a replaceable or rechargeable battery stored within or in proximity to the main electrical energizer 102. In one such embodiment, a rechargeable battery may be recharged from a solar energy panel (not shown) disposed in a sun-lit environment and connected to the rechargeable battery.

The perimeter 106 of the electric fence system 100 may be several hundred or several thousand feet long, or even miles long. Most typically, the main electrical energizer 102 is placed at a location along the fence perimeter 106 which a human operator of the system 100 may conveniently access. That location may be, for example, in or near a barn or other building used by the operator to conduct business. Also, while the perimeter 106 shown in FIG. 1 is rectangular in shape, in other embodiments the perimeter 106 may be any shape or configuration desired by the user of the electric fence system 100.

The main electrical energizer 102 contains a high voltage generator 116 to generate high voltage electrical signals which are supplied to the wires 104 in order to form an electric barrier between the enclosed area 108 and the outer area 110. The voltage generated by the energizer 102 is applied to one or more “hot” wires 104 which form the perimeter 106. An electrical pathway is commonly provided back to the main energizer 102 by the earth underneath the electric fence system 100, which is picked up by a metal ground rod 118 connecting the main energizer 102 to the earth. Although less common, an electrical pathway may alternatively be provided back to the main energizer 102 by one or more “ground” wires 104 which form the perimeter 106 but which are insulated from the hot wires 104 of the perimeter 106. When an animal contacts the electric wires 104 along the perimeter 106 of the fence system 100, an electrical circuit is completed and thus provides an electrical shock to the animal.

Several different kinds of electric fence high voltage generators 116 are known. In a first embodiment, the generator 116 delivers a continuous voltage to the hot wires 104. In a second embodiment, the generator 116 delivers a pulsed voltage to the hot wires 104. A commonly used pulse generator 116 stores energy in a capacitor which is periodically discharged to the hot wires 104 via a transformer. A pulse generator 116 is usually preferred to a continuous generator 116 to reduce the energy consumption of the electric fence system 100, and also so that the current passing through the animal is limited to keep the shock safe. A typical pulse period is on the order of 1 or 2 seconds. In a particularly preferred embodiment, the generator 116 is a low impedance pulse generator.

Many different configurations are known in the art to support the wires 104 as they extend out to form the perimeter 106. In their most basic form, each wire 104 is a highly conductive metal strand which is supported by a series of posts 112 to define the perimeter 106. In other embodiments, the conductive wires 104 may be intermixed with insulating or relatively less conductive supporting strands (not shown) in a combined rope structure. Such combined rope structures provide many advantages, such as a higher physical strength, a longer durability, greater redundancy in the event one of the wires 104 is severed, and other advantages. Combined rope structures may be formed in many ways, such as twisting the high-conductive wires 104 and the low-conductive strands together, braiding them together, weaving them into a flat tape structure, and the like.

One or more remote energizer units 120 may be disposed along the perimeter 106 of the electrical fence system 100. Each remote energizer unit 120 operates to amplify and add power to the electrical signals generated within the hot wires 104 by the main energizer 102. Each remote energizer 120 has an electrical power source connection 122, which can take the form of any of the power source connections discussed above in relation to the main energizer 102.

Each remote energizer 120 also has a voltage generator 124, usually of a much lower power rating (as measured in Joules for example) than the high voltage generator 116 of the main energizer 102. The voltage generator 124 of the remote energizer 120 generates electrical pulses which are supplied to the hot wires 104 in order to supplement the high voltage electrical impulses supplied by the main energizer 102. As with the main energizer 102, an electrical pathway may be provided back to the remote energizer 120 either by the earth underneath the electric fence system 100 or by insulated ground wires 104 forming the perimeter 106.

The voltage generator 124 of the remote energizer 120 may provide a continuous voltage or a pulsed voltage, as already discussed above in connection with the high voltage generator 116. However, a pulsed voltage generator 124 in the remote energizer 120 has the same benefits over a continuous voltage generator 124 as discussed above. Whatever voltage is added to the system 100 by the remote energizer 120 supplements the voltage supplied by the main generator 102, particularly along the perimeter 106 in the vicinity of the remote energizer 120.

In the event both energizers 102 and 120 contain pulsed voltage generators, the frequency and length of the respective pulses may be either synchronized or unsynchronized in time. It is advantageous however if the respective pulses are synchronized. In one embodiment, the pulses may be synchronized by the remote energizer 120. For example, the remote energizer 120 may include a voltage meter 126 to monitor the voltage present in the hot wires 104 at the location of the remote energizer 120. The remote energizer 120 may then time its supplemental voltage pulses to coincide with the main voltage pulses detected by the voltage meter 126. The remote energizer 120 may simply reactively supply its supplementary voltage at each moment it detects a main voltage spike from the main energizer 102. The remote energizer 120 may alternatively use the voltage meter 126 to determine the frequency and length of the main voltage pulses generated by the main electrical energizer 102, and proactively match that detected pattern.

In a further embodiment, the remote energizer 120 may use the voltage meter 126 to conserve the power consumption of the remote energizer 120. In a first embodiment, the remote energizer 120 may supply a supplemental voltage only if the main voltage from the main energizer 102 falls below a pre-set minimum threshold value. In that way, the remote energizer 120 does not consume energy supplying a supplemental voltage unless and until it is actually needed. In a further embodiment, the remote energizer 120 may use the monitored main voltage from the main energizer 102 to vary the amount of supplemental voltage added to the system 100 by the remote energizer 120. For example, the remote energizer 120 may supply only an amount of supplemental voltage needed so that, when combined with the main voltage, a pre-set target total voltage is delivered to the system 100.

One or more remote energizers 120 may be advantageously used in many situations. Existing electrical fence systems 100 can encounter a multitude of problems, especially in relation to maintaining the systems 100 in good working order after they are initially installed. The main electrical energizer 102 needs to be able to supply a sufficiently high voltage to the hot wires 104 in order to effectively deter breach of the fence perimeter 106 by an animal. Generally, a minimum of about 2,000 Volts should be maintained along the perimeter 106 to repel most animals. Over time, however, areas of high electrical resistance can develop along the perimeter 106 for a variety of reasons. Animals which encounter the electric fence system 100 and are shocked can some times damage the wires 104. And, if grass or other vegetation grows high enough to contact the hot wires 104 along the perimeter 106, the vegetation may divert current from the hot wires 104 especially if the vegetation is wet. Moreover, the voltage at areas which are very remote from the main energizer 102 will naturally be less than the voltage at areas close to the main energizer 102, due to the resistance in the wires 104. In these and other ways, one or more portions of the fence perimeter 106 may fall below the desired minimum voltage for the fence system 100 to provide an effective electrical deterrent to the passage of animals throughout the entire perimeter 106.

Also, the needs of the user of the electrical fence system 100 can change over time. In some instances, the user will want to increase the size of the enclosed area 108 defined by the fence perimeter 106. Such expansion, however, is limited by the voltage rating of the main energizer 102. Electrical fence energizers are often rated by a maximum perimeter 106 length which may be energized, and/or a maximum enclosed area 108 which may be protected, at a specified voltage level. If the user needs to increase the size of the enclosed area 108 beyond those rated limits, currently the user needs to purchase a new and higher-rated main energizer 102.

Thus, one or more remote energizer units 120 may be added to the electric fence system 100 in order to increase the size of the enclosed area 108 beyond the maximum size which the main energizer 102 could power alone. In another situation, one or more remote energizer units 120 may be added to increase the power of the electrical signals generated by the main energizer 102 in order to help bridge regions of high resistance in the electrical circuit. In this way, adding one or more remote energizers 120 to an existing electric fence system 100 provides a scalable solution to meet the changing needs of the user over the course of time.

While the present invention has been illustrated by the description of embodiments thereof and while the embodiments have been described in considerable detail, it is not the intention of the applicant to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicant's general inventive concept.

We claim:

1. An electrical fence system comprising:
a main electrical energizer connected to at least one electrically conductive hot wire which forms a fence perimeter, wherein the main energizer comprises an electrical power source connection and a main voltage generator to supply a main voltage to the at least one hot wire; and
a remote electrical energizer disposed along the fence perimeter and connected to the at least one hot wire, wherein the remote energizer comprises an electrical power source connection and a supplemental voltage generator to supply a supplemental voltage to the at least one hot wire.

2. The electrical fence system of claim 1, wherein the main voltage generator delivers a pulsed main voltage to the at least one hot wire.

3. The electrical fence system of claim 2, wherein the supplemental voltage generator delivers a pulsed supplemental voltage to the at least one hot wire.

4. The electrical fence system of claim 3, wherein the remote energizer synchronizes the pulsed supplemental voltage with the pulsed main voltage.

5. The electrical fence system of claim 3, further comprising more than one hot wire connected to the main energizer to form the fence perimeter.

6. The electrical fence system of claim 3, wherein the main energizer power source connection comprises a wire and plug for receipt in a standard electrical outlet.

7. The electrical fence system of claim 3, wherein the remote energizer power source connection comprises leads for connecting to opposing terminals of a battery.

8. The electrical fence system of claim 7, further comprising a solar energy panel connected to the battery for recharging the battery.

9. The electrical fence system of claim 3, wherein a complete electrical circuit is established by the earth underneath the electric fence system when an animal standing on the earth contacts the fence.

10. The electrical fence system of claim 3, further comprising more than one remote energizer unit.

11. The electrical fence system of claim 3, wherein the remote energizer further comprises a voltage meter to monitor the main voltage, and the remote energizer supplies the supplemental voltage only if the main voltage falls below a minimum threshold value.

12. The electrical fence system of claim 3, wherein the remote energizer further comprises a voltage meter to monitor the main voltage, and the remote energizer varies an amount of the supplemental voltage to provide a combined voltage which is at least as great as a target voltage.

13. A method of supplementing a main voltage applied at a location of high electrical resistance along a perimeter of a pre-existing electrical fence system, wherein the pre-existing electrical fence system comprises a main electrical energizer having a main voltage generator to supply the main voltage to at least one electrically conductive hot wire which forms the fence perimeter, and the method comprises adding a remote electrical energizer to the pre-existing system at or in proximity to the location and connecting the remote energizer to the at least one hot wire, wherein the remote energizer comprises an electrical power source connection and a supplemental voltage generator to supply a supplemental voltage to the at least one hot wire.

14. The method of claim 13, wherein the main voltage generator delivers a pulsed main voltage to the at least one hot wire, the supplemental voltage generator delivers a pulsed supplemental voltage to the at least one hot wire, and the remote energizer synchronizes the pulsed supplemental voltage with the pulsed main voltage.

15. A method of increasing a size of an enclosed area defined by a perimeter of a pre-existing electrical fence system, wherein the pre-existing electrical fence system comprises a main electrical energizer having a main voltage generator to supply the main voltage to at least one electrically conductive hot wire which forms the fence perimeter, and the method comprises adding a remote energizer to the pre-existing system and connecting the remote energizer to the at least one hot wire, wherein the remote energizer comprises an electrical power source connection and a supplemental voltage generator to supply a supplemental voltage to the at least one hot wire.

16. The method of claim 15, wherein the main voltage generator delivers a pulsed main voltage to the at least one hot wire, the supplemental voltage generator delivers a pulsed supplemental voltage to the at least one hot wire, and the remote energizer synchronizes the pulsed supplemental voltage with the pulsed main voltage.
